(19) United States
(12) Patent Application Publication
(10) Pub. No.: US 2013/0233614 A1
(43) Pub. Date: Sep. 12, 2013

(54) HIGH-VOLTAGE BUSHING FOR DC VOLTAGE

(71) Applicant: SIEMENS AKTIENGESELLSCHAFT, Muenchen (DE)

(72) Inventors: ENGELBERT ENGELS, KOELN (DE); ACHIM LANGENS, LOHMAR (DE); JOACHIM TITZE, RATINGEN (DE)

(73) Assignee: SIEMENS AKTIENGESELLSCHAFT, MUENCHEN (DE)

(21) Appl. No.: 13/790,123

(22) Filed: Mar. 8, 2013

(30) Foreign Application Priority Data
Mar. 8, 2012 (DE) 10 2012 203 709.8

(51) Int. Cl. H02G 3/22

(52) U.S. Cl. CPC H02G 3/22
USPC 174/650

(57) ABSTRACT

A high-voltage bushing for DC voltage in a gas-insulated, metal-encapsulated DC voltage switchgear assembly is provided with electrically conductive inserts. The novel high-voltage bushing is configured with a short, compact design, as it has at one or both ends, an inner conical cutout that opens towards the respective end.

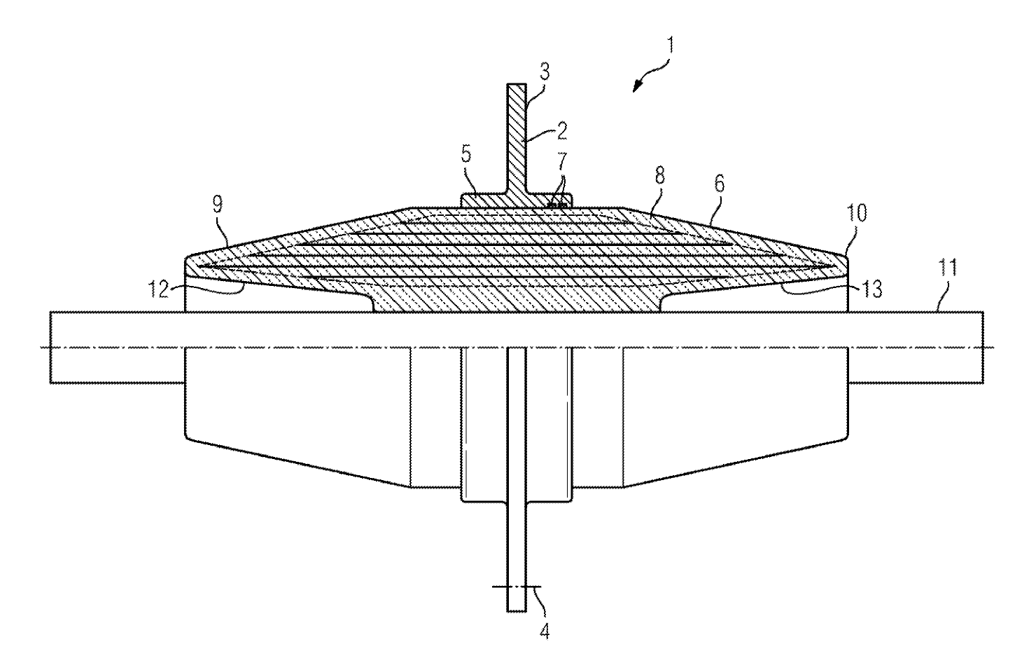

### CROSS-REFERENCE TO RELATED APPLICATION

This application claims the priority, under 35 U.S.C. §119, of German patent application DE 10 2012 203 709.8, filed Mar. 8, 2012; the prior application is herewith incorporated by reference in its entirety.

### BACKGROUND OF THE INVENTION

### Field of the Invention

The invention relates to a high-voltage bushing for DC voltage with electrically conductive inserts.

A high-voltage bushing of the generic type is known from Andreas Kuchler, “Hochspannungstechnik”, 2nd edition, 2005, pages 100 and 101. That high-voltage bushing is configured so as to be conically tapering at one of its ends. The electrically conductive inserts have a continuously increasing length in the axial direction from the outside to the inside.

### SUMMARY OF THE INVENTION

It is accordingly an object of the invention to provide a pass-through bushing for a DC voltage which overcome various disadvantages of the heretofore-known devices of this general type and which provides for such a high-voltage bushing with a short, compact configuration.

With the foregoing and other objects in view there is provided, in accordance with the invention, a high-voltage lead-through bushing for DC voltage. The bushing comprising:

electrically conductive inserts extending between first and second ends of the bushing; and

the high-voltage bushing being formed, at least at one of the first and second ends with an inner conical cutout opening out towards the at least one end.

In other words, the object is achieved, in the case of a high-voltage bushing of the type specified at the outset, according to the invention, with a high-voltage bushing having, at least at one end, an inner conical cutout which opens towards this end.

A primarily important advantage of the high-voltage bushing according to the invention is considered to be the fact that it is considerably shortened in length in comparison with the known high-voltage bushing because the region within the inner conical design is also utilized for voltage control. The high-voltage bushing according to the invention therefore has a comparatively short structural form in the axial direction.

In respect of its other end, the high-voltage bushing can be designed differently, depending on use; it is considered to be particularly advantageous, again for achieving a relatively short axial length, if the high-voltage bushing has, at its other end, a further inner conical cutout which opens towards this end.

The high-voltage bushing according to the invention can be configured differently in respect of its high-voltage-conducting inner part. It appears to be advantageous if a high-voltage-conducting conductor extends centrally between the two inner conical cutouts.

Such an embodiment of the high-voltage bushing according to the invention is particularly advantageous when the high-voltage bushing is arranged in a barrier plate of a gas-insulated, metal-encapsulated DC voltage switchgear assembly because a gas-insulated metal-encapsulated DC voltage switchgear assembly represents a compact switchgear assembly to the compact design of which the high-voltage bushing according to the invention with this configuration advantageously contributes.

For the insulation of the high-voltage bushing, different insulating materials can be used; however, it is considered to be particularly advantageous if the insulation of the high-voltage bushing consists of resin-impregnated paper because such a high-voltage bushing can be produced in a gas-tight manner. Such a bushing can be used in a barrier plate with particular advantage, in particular for gas-insulated switchgear assemblies.

Other features which are considered as characteristic for the invention are set forth in the appended claims.

Although the invention is illustrated and described herein as embodied in a high-voltage bushing for DC voltage, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of a specific embodiment when read in connection with the accompanying drawing.

### BRIEF DESCRIPTION OF THE DRAWING

The sole FIGURE of the drawing is a partly sectional view of a high-voltage pass-through bushing according to the invention, in a barrier plate of a gas-insulated metal-encapsulated DC voltage switchgear assembly.

### DETAILED DESCRIPTION OF THE INVENTION

Referring now to the FIGURE of the drawing in detail, there is shown a high-voltage bushing 1 in a barrier plate 2 of a gas-insulated, metal-encapsulated high-voltage switchgear assembly. The latter is not further illustrated in order not to complicate the disclosure unnecessarily. The barrier plate 2 can be screwed to non-illustrated flanges of the metal encapsulation of the gas-insulated high-voltage switchgear assembly. For that purpose, the barrier plate 2 is formed with bores 3 and 4.

The high-voltage bushing 1 can be arranged so as to be sealed by means of sealing rings 7 within a ring-shaped attachment 5 of the barrier plate 2. The high-voltage bushing 1 has electrically conductive inserts 8, which are formed from conductive cylinders with different diameters and different lengths.

As is also shown in the FIGURE, the high-voltage bushing 1 is provided with an outer cone at in each case its one end 9 and its further end 10. The outer cones, however, do not reach as far as a high-voltage conducting conductor 11 of the metal-encapsulating DC voltage switchgear assembly. The high-voltage bushing 1 has an inner conical cutout 12 at its one end 9 and a further conical cutout 13 at its other end 10. The inner conical cutouts 12 and 13 each open out towards the ends 9 and 10, respectively, of the high-voltage bushing 1. As a result of this, to a certain extent, reverse control is performed by means of the electrically conductive inserts 8 in the region of the inner conical cutouts 12 and 13. This has the effect that the high-voltage bushing 1 is configured so as to be comparatively short in the axial direction.

The insulation of the high-voltage bushing 1 may be formed of different materials, for example casting compound, such as casting resin. In the illustrated embodiment, resin-impregnated paper is preferred for the insulation of the high-voltage bushing 1. This applies in particular to the use of the high-voltage bushing 1 in gas-insulated switchgear assemblies because a high-voltage bushing 1 with such insulation can be provided with the conductive inserts 8 in a relatively simple manner.

1. A high-voltage bushing for DC voltage, the bushing comprising:
electrically conductive inserts extending between first and second ends;
the high-voltage bushing being formed, at least at one of said ends with an inner conical cutout opening out towards said at least one end.

2. The high-voltage bushing according to claim 1, wherein said inner conical cutout opens out towards said first end and the high-voltage bushing is formed with a further inner conical cutout at said second end and opening out towards said second end.

3. The high-voltage bushing according to claim 2, which comprises a high-voltage-conducting conductor extends centrally between said inner conical cutout at said first end and said further inner conical cutout at said second end.

4. The high-voltage bushing according to claim 1, wherein the high-voltage bushing is disposed in a barrier plate of a gas-insulated, metal-encapsulated DC voltage switchgear assembly.

5. The high-voltage bushing according to claim 1, which comprises insulation consisting of resin-impregnated paper.

6. In a gas-insulated, metal-encapsulated DC voltage switchgear assembly, the high-voltage bushing according to claim 1 disposed in a barrier plate of the switchgear assembly.
